(19) United States
(12) Patent Application Publication
(10) Pub. No.: US 2018/0004901 A1
(43) Pub. Date: Jan. 4, 2018

(54) SYSTEMS AND METHODS FOR HOLISTIC ANALYSIS OF MEDICAL CONDITIONS

(71) Applicant: GENERAL ELECTRIC COMPANY, Schenectady, NY (US)

(72) Inventors: Gopal Biligeri Avinash, San Ramon, CA (US); Saad Ahmed Sirohey, Pewaukee, WI (US)

(21) Appl. No.: 15/199,631

(22) Filed: Jun. 30, 2016

(51) Int. Cl. G06F 19/00

(52) U.S. Cl. CPC G06F 19/325; G06F 19/321; G06F 19/345

(57) ABSTRACT

A system includes an input unit, a data store, at least one processor, and a display unit. The input unit is configured to obtain operational parameters relating to the performance of at least one process during a therapeutic cycle of a patient. The data store includes reference values of the operational parameters that correspond to at least one known patient outcome. The at least one processor is operably coupled to the input unit, and is configured to evaluate the operational parameters to determine a patient process progress state based on a comparison between values of the operational parameters and corresponding reference values. The display unit is operably coupled to the at least one processor, and is configured to display information corresponding to the patient process progress state.

### BACKGROUND OF THE INVENTION

The subject matter disclosed herein relates generally to systems and methods for medical analysis and treatment, for example to systems and methods for holistic analysis of medical conditions and/or treatment of medical conditions.

A number of processes may be performed after a patient is identified as having or is suspected of having a given condition. However, the relative effect of any one particular process on the patient outcome, and/or the framework within which any given process or group of processes may be performed (e.g., time limits within which a process should be performed) may be unknown or inadequately described or understood by current approaches.

### BRIEF DESCRIPTION OF THE INVENTION

In one embodiment, a system is provided that includes an input unit, a data store, at least one processor, and a display unit. The input unit is configured to obtain operational parameters relating to the performance of at least one process during a therapeutic cycle of a patient. The data store includes reference values of the operational parameters that correspond to at least one known patient outcome. The at least one processor is operably coupled to the input unit, and is configured to evaluate the operational parameters to determine a patient process progress state based on a comparison between values of the operational parameters and corresponding reference values. The display unit is operably coupled to the at least one processor, and is configured to display information corresponding to the patient process progress state.

In another embodiment, a method is provided that includes performing a process during a therapeutic cycle of a patient. The method also includes entering information regarding the process into an input unit. Further, the method includes determining, with at least one processor, a value of at least one operational parameter using the information regarding the process. The method also includes comparing the value of at least one operational parameter to at least one reference value corresponding to at least one known patient outcome, to determine a patient process progress state; and displaying, on a display unit, information corresponding to the patient process progress state.

### BRIEF DESCRIPTION OF THE DRAWINGS

FIG. 1 is a schematic block diagram illustrating an imaging system in accordance with various embodiments.

FIG. 2 illustrates an example display in accordance with various embodiments.

FIG. 3 is a flowchart of a method in accordance with various embodiments.

FIG. 4 illustrates an example group of processes and parameters in accordance with various embodiments.

### DETAILED DESCRIPTION OF THE INVENTION

The following detailed description of certain embodiments will be better understood when read in conjunction with the appended drawings. To the extent that the figures illustrate diagrams of the functional blocks of various embodiments, the functional blocks are not necessarily indicative of the division between hardware circuitry. For example, one or more of the functional blocks (e.g., processors or memories) may be implemented in a single piece of hardware (e.g., a general purpose signal processor or a block of random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, the terms “system,” “unit,” or “module” may include a hardware and/or software system that operates to perform one or more functions. For example, a module, unit, or system may include a computer processor, controller, or other logic-based device that performs operations based on instructions stored on a tangible and non-transitory computer readable storage medium, such as a computer memory. Alternatively, a module, unit, or system may include a hard-wired device that performs operations based on hard-wired logic of the device. Various modules or units shown in the attached figures may represent the hardware that operates based on software or hardwired instructions, the software that directs hardware to perform the operations, or a combination thereof.

“Systems,” “units,” or “modules” may include or represent hardware and associated instructions (e.g., software stored on a tangible and non-transitory computer readable storage medium, such as a computer hard drive, ROM, RAM, or the like) that perform one or more operations described herein. The hardware may include electronic circuits that include and/or are connected to one or more logic-based devices, such as microprocessors, processors, controllers, or the like. These devices may be off-the-shelf devices that are appropriately programmed or instructed to perform operations described herein from the instructions described above. Additionally or alternatively, one or more of these devices may be hard-wired with logic circuits to perform these operations.

As used herein, an element or step recited in the singular and preceded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Various embodiments provide systems and methods for holistic analysis of medical conditions, including operational aspects of a therapeutic cycle or patient journey through the various stages of a medical condition. Insights may be obtained from operational data at one or more stages of a medical condition, with results concatenated to reveal or describe the entire journey of the patient through the medical condition. Operational metrics may be obtained at various stages of the patient journey or therapeutic cycle. As one example, in the case of a stroke patient, metrics may be obtained during one or more of onset, ambulance journey, ER visit, triaging, imaging, therapy planning, therapy, hospital stay, rehabilitation, discharge, in-home care, or the like. In various embodiments, real-time updates to a patient state evaluation (e.g., real-time updates to identified deviations of operational indicators from successful past cases to describe a patient process progress state) may be provided. In various embodiments, time trending of operational indicators and/or deviations of operational indicators from a benchmark or benchmarks may be provided. Further, various embodiments provide for identification of the relative importance of operational indicators. Also, various embodiments relate overall operational indicators with respect to successful and/or unsuccessful prior cases.

As indicated above, in various embodiments, real-time updates to a patient state evaluation (e.g., real-time updates to identified deviations of operational indicators from successful past cases) may be provided. Operational indicators may relate to the performance of a test or other procedure, for example to whether or not a test or procedure was performed, a sequence of tests or procedures, and/or a timing of a test or procedure. Examples of metrics that may be used include a time to test results, a time elapsed since an arrival (or other event), or an identification of test results pending with time elapsed since placing an order. Obtained metrics are then compared with prior cases having desired or favorable outcomes. For example, a mean and standard deviation for one or more metrics may be computed for the comparison group to provide reference values (e.g., reference values of mean and standard deviation for successful cases) for each metric analyzed. In some embodiments, a z-score for each metric for a current patient may then be computed, and the score displayed as a state or status indicator. Other indicators may be displayed alternatively or additionally. For example, for each metric that is close to a reference value for a desired outcome, a favorable indication may be displayed, for each that is relatively far from a reference value for a desired outcome, a non-favorable indication may be displayed, and for those in-between an intermediate indication may be displayed.

As also indicated above, in various embodiments, time trending of operational indicators and/or deviations of operational indicators from a benchmark or benchmarks may be provided. For example, deviations of one or more operational indicators may be determined by comparing measured values for an operational parameter (or parameters) with reference values. In some embodiments, indicators for one or more metrics (e.g., metrics of operational indicators relating to the time of performance of various tests or processes) may be updated at predetermined time increments to provide real-time comparative performance metrics. The metrics may be color-coded and change color responsive to an amount of time elapsed and/or responsive to levels of deviation from reference values of successful cases (e.g., a green indicator when metrics are close to those for successful cases, yellow when the metrics are less close, and red when the metrics are even less close).

It may also be noted that in addition to trends of deviations over time, the deviations of the trends with respect to trends of successful cases may also be analyzed in various embodiments. For example, a set of time series pertaining to each operational metric may be obtained and recorded. The time trend may be parameterized and use a generated parameter (or parameters) as a time trend metric (or metrics). Based on the trending data, a model may be obtained. For example, if an observed data trend can be modeled as a linear trend, the slope of the trend line may be used as a parameter that in turn may be used as a time trend metric. A given metric analyzed in various embodiments may relate to a single process or operation in some embodiments, or to a group or combination of processes or operations in other embodiments. As with the operational indicators themselves, the trends of operational indicators may also be analyzed by collecting reference values for cases with successful outcomes, computing mean and standard deviations for the trend reference values, computing a z-score for a current trend or trends for a current patient, and displaying the score(s) (or other representation of a patient state derived from the score(s)).

Various embodiments provide for identification of the relative importance of operational indicators. For example, the operations of a given facility or provided may be analyzed using various techniques disclosed herein, the relative importance of various operational indicators may be determined, and appropriate changes to procedures, protocols, and/or training may be implemented to improve operations to provide better outcomes for patients. For example, for a population of patients on a similar journey through a medical condition or going through a similar therapeutic cycle, operational indicators and associated outcomes may be collected and used to identify the relative importance of different operational indicators. Such identification may be used to avoid cluttering of information by segregating information based on a criterion. For example, an example criterion may be provided by choosing a ratio of areas of overlap to a total area under two populations that are considered for each metric.

For instance, in some embodiments, a first indicator may be analyzed, with corresponding indicator data pertaining to favorable and unfavorable outcome populations obtained. A measure of closeness of favorable and unfavorable populations for the first indicator may then to be determined, with the measure based on a ratio such that the value of the measure is between 0 and 1 (both inclusive). The measure may be further refined to be 1 when there is no overlap and 0 when there is complete overlap. All intermediate overlaps are represented as values between 0 and 1. The above described steps may then be repeated for all indicators to be analyzed. Next, the indicators and their overlap measures may be displayed to enable manual selection of vital or preferred indicator candidates based on their relative importance. Alternatively, instead of manual selection, a predetermined algorithm may be used to identify the relative importance based on one or more thresholds or other criteria.

Also, various embodiments may be employed to relate overall operational indicators with respect to successful and/or unsuccessful prior cases. For example, first, a plurality of operational indicators' deviations for a given patient may be related in a consistent manner, with changes to the indicators tracked over the patient journey or therapeutic cycle. Second, a landscape of a population of patients' corresponding journeys through a given medical condition may be created with several categories of favorable, unfavorable, and semi-favorable outcomes. Third, the landscape for a given patient journey may be tracked over time in the context of the landscape. Such a mapping may be used to enable users to predict early on in the patient journey the likelihood of a favorable outcome and/or to make adjustments to improve the likelihood of a favorable outcome (e.g., make adjustments or perform future processes at a time and/or in a way to more closely resemble the known prior cases with favorable outcomes). Such a prediction may be used to correct course by modifying controllable indicators, and/or to maintain a desired course by maintaining controllable indicators within a preferred range.

It may also be noted that, additionally or alternatively to operational information or operational parameters, other types of information or parameters may be used in various embodiments to determine a patient process state and/or to compare a patient's progress through a journey for a medical condition with past favorable outcomes. For example, clinical parameters relating to a patient's health or patient characteristics may be utilized. Such parameters may include imaging based parameters (information derived from medical images), waveform-based parameters (information derived from measure waveforms such as EEG's or EKG's), parameters based on test or exam results (e.g., blood test results, heart rate, breathing rate, or other information related to measurable quantities), and/or parameters based on patient characteristics and/or history (age, gender, weight, past medications, past conditions, or the like). Additionally or alternatively, deviations and/or time trends as discussed herein may be analyzed for one or more of the above listed parameters or types of parameters and used to determine a patient process progress state.

For example, a deviation view for a stroke patient across a patient journey may include, additionally or alternatively to deviations of operational parameters, one or more of image based deviations (e.g., computed tomography perfusion (CTP) based deviations, computed tomography angiography (CTA) based deviations, diffusion weighted imaging (DWI) based deviations, diffusion perfusion-based mismatch deviations); waveform-based deviations (EEG based deviations, EKG based deviations; or electronic medical record (EMR) based deviations (including deviations based on drugs, medications, blood pressure test results). Further still, in some embodiments, a combinational view of different types of deviations, for example, some or all of the above listed deviations, may be analyzed. Yet further still, time trends for one or more of the above listed parameters or types of parameters may be analyzed as discussed herein.

By way of example, one or more of the following data fields may be used to define a patient population and/or be analyzed to determine a value of an operational parameter or clinical parameter to be used in determining and/or assessing a patient process progress state: information regarding medical history and prior heath states (medical history information including past conditions, social history including smoking, drinking, drug use, or the like, current and/or past medications, prior health status (e.g., mRS functionality scale), age, gender, race/ethnicity); information regarding present illness (time of onset, severity of symptoms, identification of symptoms); information regarding laboratory tests and vital signs (blood tests, heart rate, breathing rate, or the like); information regarding treatment decisions and/or acute therapies (for example, for a stroke case, alteplase, thrombectomy, hemicraniectomy, carotid artery endarterectomy, carotid artery stenting); information regarding long-term therapy and follow-up (for example, for a stroke case, antiplatelets, anticoagulants, statins, stroke etiology: thrombotic, embolic, carotid, or the like, discharge diagnosis); information regarding outcomes and endpoints (for example, for a stroke case, mRS (at discharge and at 3 months), discharge disposition: home, rehabilitation, outpatient therapy, or the like, NIHSS (at discharge and at 3 months)). Accordingly, various pieces of information describing the patient journey may be collected and compared to reference values to track and understand a patient's progress compared to favorable outcomes, and to make any necessary adjustments to bring the patient's progress more in line with historical favorable outcomes, for example from a process or operational standpoint.

Various embodiments provide improved analysis or evaluation of medical operations. A technical effect of at least one embodiment includes providing improved prioritization of a number of operational parameters and/or associated processes (e.g., via analysis of operational parameters from a distribution based analysis). A technical effect of at least one embodiment includes providing a prioritized list of deviations of operational parameters and/or trends of operational parameters with respect to one or more reference groups (e.g., a reference group of values corresponding to successful outcomes). A technical effect of at least one embodiment includes providing improved information to a user or operator, improving performance of time critical medical applications.

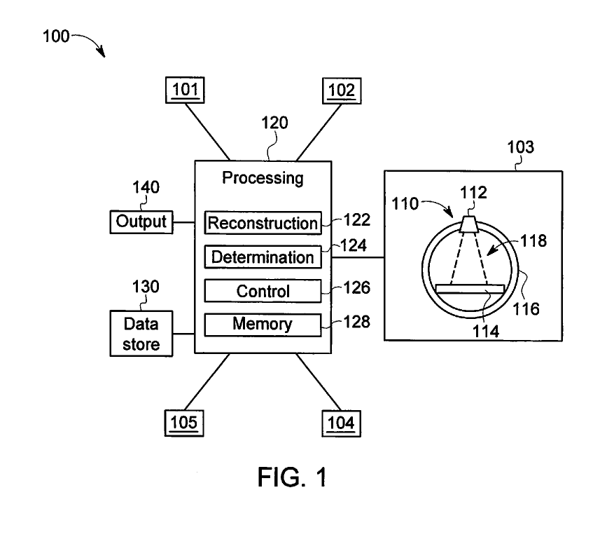

FIG. 1 illustrates a system 100 comprising a first input unit 101, a second input unit 102, a third input unit 103, a fourth input unit 104, and a fifth input unit 105. The system 100 also includes a processing unit 120, a data store 130 (shown remote from the processing unit in the depicted embodiment, but may be integral with all or part of processing unit 120 in various embodiments), and a display unit 140. Before describing the various components or aspects in more detail, a general overview is provided.

Generally, in various embodiments, at least one input unit (e.g., first input unit 101, second input unit 102, third input unit 103, fourth input unit 104, and/or fifth input 105) are configured to obtain operational parameters relating to the performance of at least one process during a therapeutic cycle of a patient. A therapeutic cycle as used herein may be understood to include one or more activities or actions performed by one or more healthcare providers (e.g., one or more providers and/or individuals including but not limited to doctors, nurses, therapists, emergency medical technicians, administrative staff, hospitals, clinics, urgent care facilities, among other others) occurring from onset to resolution of a patient condition. In various embodiments, a process as used herein for which operational parameters may be obtained include intake and/or administrative processes (e.g., picking up a patient in an ambulance, admitting a patient to a facility, or the like) as well as clinical or diagnostic processes (e.g., performing a test, imaging a patient, or otherwise collecting diagnostic information; performing a surgery or other treatment on a patient; administering one or more medications to a patient; providing a therapy (e.g., rehabilitation) to a patient; or the like).

The operational parameters may represent, for example, one or more of whether or not a particular process has been performed, the time it took to perform a process, the time elapsed since a process has been performed, the time elapsed between performance of two or more processes, and/or a sequence in which a number of processes were performed. Operational parameters as used herein relate to the performance of at least one process during a therapeutic cycle pertaining to a medical condition, and may relate to one or more of transporting a patient, triaging a patient, detecting a condition, diagnosing a condition, or treating a condition, for example. In various embodiments, the operational parameters may include at least one timing parameter. For example, the at least one timing parameter may include a time since a test has been performed, and/or a time since arrival at a facility, and/or other timing parameters discussed herein.

It may be noted that, alternatively or additionally to the use of operational parameters, one or more values of clinical parameters may be used in various embodiments. Clinical parameters, in contrast to operational parameters, relate to the description of the health of a patient instead of the performance of a process. In various embodiments, one or more input units (e.g., 101, 102, 103, 104, 105) are configured to obtain clinical parameters relating to diagnostic information of a patient, with the data store 130 including reference values of the clinical parameters that correspond to at least one known patient outcome (e.g., a favorable or successful outcome), and the processing unit 120 may evaluate the clinical parameters additionally or alternatively to the operational parameters to determine the patient process progress state. Values of clinical parameters may be obtained using diagnostic information, such as imaging information, or, as another example of diagnostic information, information obtained from one or more tests or exams, such as blood pressure, heart rate, breathing rate, or the like. Further still, clinical parameters may relate to patient characteristics or history, such as age, previous conditions, or medications.

The data store 130 includes a tangible and non-transitory computer readable medium, and includes (e.g., has stored therein) reference values of the operational parameters (and/or clinical parameters in various embodiments) that correspond to at least one known patient outcome. For example, a reference value or values for a favorable patient outcome may be stored. The reference value or values may be based on parameter values for previous cases with known favorable outcomes. Additionally, reference values for moderately favorable and/or unfavorable outcomes may be stored in various embodiments. A reference value for a favorable outcome may be represented by a single value for a given parameter, a range of values for a given parameter, a suite of values for a corresponding group of parameters, or a combined value for a group of parameters, for example. The processing unit 120 is coupled to the input units and is configured to evaluate one or more operational parameters obtained from the input units to determine a patient process progress state based on a comparison between values of the operational parameters and corresponding reference values from the data store 130. For example, the processing unit 120 may be programmed to determine a deviation or difference (e.g., a number of standard deviations) from the reference values by the obtained operational parameter values. The farther the operational parameters are from reference values, the more the patient process progress state may be understood as deviating from the patient outcome associated with the reference values. The patient process progress state may be described in relative terms with respect to a patient outcome. For example, when values of operational parameters are relatively close to reference values for a favorable outcome, the patient process progress state may be rated as favorable or acceptable. When the values deviate beyond an acceptable threshold from the reference values, the patient process progress state may be rated as unfavorable or unacceptable. The threshold may be determined based on the deviation from the favorable reference values by values of operational parameters for known cases with unfavorable outcomes. In various embodiments, a sliding scale of ratings (e.g., 1-10, with 1 being least favorable and 10 being most favorable) may be employed to describe or evaluate the patient process progress state. The display unit 140 is operably coupled to the processing unit 120, and is configured to display information corresponding to the patient process progress state. For example, the display unit 140 may display a determined patient process progress state along with values of operational parameters for the present case and/or reference values of operational parameters.

It may be noted that various embodiments may include additional components, or may not include all of the components shown in FIG. 1 (for example, various embodiments may utilize some or all of the various input units, or may utilize additional input units alternatively or additionally). Further, it may be noted that certain aspects of the imaging system 100 shown as separate blocks in FIG. 1 may be incorporated into a single physical entity, and/or aspects shown as a single block in FIG. 1 may be shared or divided among two or more physical entities.

As discussed herein, the depicted input units 101, 102, 103, 104, 105 are configured to obtain operational parameters relating to the performance of at least one process during a therapeutic cycle of a patient. Information corresponding to various operational parameters may be input automatically and/or manually. The input units may obtain an operational parameter by receiving the value of the parameter, receiving information corresponding to a parameter and determining the value of the parameter, or receiving information from which another aspect of the system 100 (e.g., processing unit 120) may determine the actual value of the parameter. For example, a given input unit may directly receive a value of a parameter from an operator. As another example, the input unit (and/or processing unit 120) may obtain a value of a parameter using information entered by an operator. For example, an operator may press a button or provide another input when a test or other process is complete, with the input unit and/or processing unit 120 determining a time when the button was pushed and calculating an elapsed time from performance of a previous process. Such information may in some embodiments be entered as part of an interactive process. For example, one or more processes may be identified or displayed on a screen associated with an input unit. An operator may then identify processes that are performed when they are performed, or enter a time of performance for one or more processes, with the processing unit 120 and/or input unit determining an elapsed time between processes, and using the elapsed time as an operational parameter. As another example, a value of an operating parameter (operational and/or clinical) may be obtained automatically. For instance, imaging information (e.g., a reconstructed image or objective measure corresponding to a reconstructed image) may be automatically obtained, and an objective measure determined from the imaging information (e.g., one or more quantitative measures provided by a CT perfusion imaging process) may be used to obtain a value of a clinical parameter. Again, such information may be obtained interactively. For example, an image may be reconstructed and displayed, with an input received from an operator analyzing the image used to determine the value of a clinical and/or operational parameter.

Five different input units are depicted in the example illustrated in FIG. 1. It may be noted that input units may be mobile or stationary, and may obtain inputs automatically (e.g., without operator action or intervention) or manually (e.g., with operator action or intervention). The various input units may be configured to accept a manual user input, such as via a touchscreen, keyboard, mouse, or the like. Additionally or alternatively, a given input unit may receive information automatically (e.g., from an imaging or testing system or sensor; another system; or a remote computer), for example, via a port or other connectivity device.

In the illustrated embodiment, the first input unit 101 is a mobile input unit. For example, the first input unit 101 may be configured as a smartphone or tablet, or associated with a smartphone or tablet. In various embodiments, the first input unit 101 may be disposed on or associated with an ambulance. Information obtained via the first input unit 101 include operational information including information regarding when a patient is picked up, when one or more tests (e.g., blood pressure test) are performed, and/or when one or more medications are administered, and/or clinical information including results of various tests (e.g., blood pressure, heart rate, breathing rate, EKG results).

The second input unit 102 in the illustrated embodiment is an administrative input unit. The second input unit 102 may be disposed at or associated with an administrative station, for example, of a clinic or a hospital. Information obtained via the second input unit 102 may include, for example, information relating to when a patient is admitted to a facility, patient information such as age, gender, weight, or the like, previous conditions or other aspects of the patient history obtained via medical records, or the like.

The third input unit 103 in the illustrated embodiment is an imaging input unit. The third input unit 102 may be disposed at or associated with an imaging system. For example, the third input unit 102 may be used to automatically obtain imaging information that may be used to determine operational parameters (e.g., regarding the performance of a particular scan and/or timing information of when the particular scan was performed) and/or clinical parameters (e.g., parameters describing a patient health state derived from a reconstructed image). The third input unit 102 may be configured to receive an operator input (e.g., describing a time of initiating or performing a particular scan, or describing results of an image viewed by the operator).

In the illustrated embodiment, the third input unit 102 includes or is associated with a computed tomography (CT) imaging system; however, it. may be noted that other imaging modalities, including X-ray, positron emission tomography (PET), single photon emission computed tomography (SPECT), magnetic resonance imaging (MRI), or ultrasound, among others, may be utilized alternatively or additionally. The depicted third input unit 103 is associated with a CT acquisition unit 110 that in turn includes an X-ray source 112 and a CT detector 114. (For additional information regarding such a CT system, including examples of imaging sequences that may be utilized in various embodiments, see U.S. patent application Ser. No. 15/072,071, “Systems and Methods for Progressive Imaging,” filed 16 Mar. 2016, the entire subject matter of which is incorporated by reference herein.) The X-ray source 112 and the CT detector 114 (along with associated components such as bowtie filters, source collimators, detector collimators, or the like (not shown in FIG. 1)) may rotate about a central axis of a bore of a gantry 116 of the system 100.

Generally, X-rays from the X-ray source 112 may be guided to an object to be imaged through a source collimator and bowtie filter. The object to be imaged, for example, may be a human patient or a portion thereof (e.g., head or torso, among others). The source collimator may be configured to allow X-rays within a desired field of view (FOV) to pass through to the object to be imaged while blocking other X-rays. The bowtie filter module may be configured to absorb radiation from the X-ray source 112 to control distribution of X-rays passed to the object to be imaged.

X-rays that pass through the object to be imaged are attenuated by the object and received by the CT detector 114 (which may have a detector collimator associated therewith), which detects the attenuated X-rays and provides imaging information to the processing unit 120. The processing unit 120 may then reconstruct an image of the scanned portion of the object using the imaging information (or projection information) provided by the CT detector 114.

In the illustrated embodiment, the X-ray source 112 is configured to rotate about the object. For example, the X-ray source 112 and the CT detector 114 may be positioned about a bore 118 of the gantry 116 and rotated about the object to be imaged. As the X-ray source 112 rotates about the object during an imaging scan, X-rays received by the CT detector 114 during one complete rotation provide a 360 degree view of X-rays that have passed through the object. Other imaging scanning ranges may be used in alternative embodiments. The CT imaging information may be collected as a series of views that together make up a rotation or portion thereof. A blanking interval may separate a first view or projection from the next view or projection in the series.

In the illustrated embodiment, the fourth input unit 104 is an evaluation input unit 104. The fourth input unit 104 may be disposed at or associated with, for example, a triaging station, emergency room, examination room, or testing facility. Information obtained via the fourth input unit 104 may include results of examinations and/or information regarding the timing of performance of examinations.

The fifth input unit 105 in the illustrated embodiment is a treatment input unit 104. The fifth input unit 105 may be disposed at or associated with a treatment or therapy location, such as an operating room or therapy facility. Information obtained via the fifth input unit 104 may include information regarding the identification of particular treatments (e.g., surgeries or therapies) provided, the timing of such treatments, and/or results of such treatments.

The depicted data store 130 includes one or more tangible and non-transitory computer readable storage media. While the data store 130 is depicted as a single block in FIG. 1, it may be noted that the data store 130 may be distributed among multiple physical sites and/or may be incorporated into the processing unit 120. Generally, the data store 130 is used to store reference values of operational and/or clinical parameters that correspond to at least one known patient outcome. In some embodiments, only one patient outcome may be used. For example, a successful or favorable patient outcome may have reference parameters values and allowable deviations associated therewith. In other embodiments, a scale of reference values ranging from an unfavorable or unsuccessful outcome to a favorable or successful outcome with one or more intermediate values corresponding to a partially favorable outcome may be utilized, with the level of success or favorability of the closest reference values corresponding to obtained operational and/or clinical parameters used to identify a patient process progress state.

In various embodiments, the reference values are computed parameters using operational data from a number of patients that may be understood as a reference population or peer population. In some embodiments, the comparison of operational parameter values for a current case with reference values may correlate the values of operational parameters and patient outcomes based on successfulness or unsuccessfulness. For example, the reference population may be defined as patients that had a desired, favorable, or successful outcome, and the operational parameters considered with respect to reference values from the cases having a successful outcome. For example, an average time and standard deviation of time taken for ordering and/or performing a particular test (e.g., a blood test) for a number of patients that had a desired outcome may be the reference parameters. The reference parameters may be used to compute Z-scores of an operational value using A/D, where A is the average value and D is the standard deviation of “n” total patients having a desired outcome that define the reference population. It should be noted that the reference parameters are obtained from a reference patient population going through the same process as the current patient. In various embodiments, the patient process progress state may be understood as representing the change or development of a patient's process state over time. The reference values may then pertain to the time sequences of operational data from the reference population with the desired patient outcome. Continuing with the present example, the sequential change over time of a series of blood test values may be modeled as a function. For example, a linear function may be used as discussed herein; however, non-linear functions may also be modeled. If a linear function is modeled, a slope parameter of the linear function may be used for each sequential blood test. These parameters may then be used to compute an average and standard deviation, and Z-scores pertaining to the sequential blood tests of a given patient may be computed. It may further be noted that the processing unit 120 may update the reference values using obtained operational parameters (e.g., once the outcome of a current case may be established, if the outcome is favorable or successful, the current case may be added to a patient population in the data store 130 to generate a revised patient population, and the reference values re-calculated or updated using the revised patient population).

In one example in which a series of tests are performed, let the time at which a series of m tests were taken for a given patient be represented as T1, T2, T3, . . . Tm. Assuming a linear relationship over time, this sequence may be represented by a slope S. Repeating the test for n patients of a reference population, a total of n slopes may be obtained. An average slope Savg and a standard deviation D may next be determined for the n slopes. Then, for a given current patient X, the series of m tests may be administered, with the corresponding times recorded and used to obtain a slope SX, for which a Z-score may be determined, for example using (SX−Savg)/D. The Z-score may be displayed to show a patient progress state. It may be noted that the above example, for clarity and ease of illustration, was described in terms of a series of the same test. However, in various embodiments, more complicated models may be used, for example, to take additional processes (e.g., other types of tests) into account, and/or to combine clinical parameters with process parameters. In various embodiments, a single score or metric may be used to account for a combination of processes and/or clinical parameters, and/or separate scores or metrics may be shown for individual parameters or sub-groups of parameters.

It may be noted that different types or arrangements of parameters and reference numbers may be used in various embodiments. For example, some parameters may be given a greater weight than other parameters when determining a patient process progress state. As another example, in some embodiments, reference values may be correlated to a single patient outcome, while in other embodiments, a scale of reference values (e.g., ranging from least successful to most successful outcome) may be utilized. Generally, the reference values are used to provide historical information on previous cases so that a current case may be evaluated with respect to past cases, to identify whether the current case is progressing comparably to cases having successful outcomes, and/or to recommend alterations, adjustments, or other activities to be performed for the present case, for example to more closely resemble past cases with successful outcomes.

In the illustrated embodiment, the processing unit 120 is coupled (e.g., via a wired connection, wireless connection, cloud arrangement) to the input units. The depicted processing unit 120 evaluates the operational parameters obtained via the input units to determine a patient process progress state based on a comparison between values of the operational parameters and corresponding reference values. The patient process progress state describes a state or condition of a patient during a therapeutic cycle. In various embodiments, the patient process progress state describes the condition of the patient relative to comparable previous patients at a similar point in the same therapeutic cycle that had favorable or successful outcomes. For example, a stroke patient may be evaluated to provide a patient process progress state as the patient receives various tests and/or treatments, to understand how the therapeutic cycle is proceeding for the patient relative to previous patients. For example, if tests and/or treatments are being performed in a timely fashion relative to successful patient outcomes, a generally positive patient process progress state may be determined. However, if tests and/or treatments are not being performed in a timely fashion relative to successful patient outcomes, a generally negative patient process progress state may be determined.

In some embodiments, the reference values may correspond to a peer population of the patient, for example a group of patients previously undergoing a similar therapeutic cycle or patient journey that have had successful outcomes. The processing unit 120 may be configured to revise or redefine the patient population based on information obtained during the current therapeutic cycle. For instance, the processing unit 120 may obtain information indicating a refined view of a current medical condition, and re-define the peer population (and corresponding reference values) to reflect the refined view. As one example, a patient originally diagnosed with a stroke may be imaged to help determine whether the stroke is hemorrhagic or ischemic. Accordingly, the processing unit 120 may obtain imaging information of the patient (e.g., an image and/or an operator's evaluation of the image indicating the type of stroke), and re-define the patient population using the imaging information. For example, if ischemic stroke is indicated, the patient population may be revised to include only ischemic stroke cases, and the reference values used for future evaluation of the patient process progress state may be from the ischemic stroke cases of the refined patient population.

In some embodiments, the processing unit 120 is configured or programmed to evaluate operational parameters to provide, via the display unit 140, a performance metric corresponding to the patient process progress state. The performance metric may be a dimensioned metric, such as an elapsed time since a given process has occurred, or a dimensionless metric, such as a ratio of an elapsed time (or other parameter) to a target elapsed time (or other parameter). In some embodiments, the performance metric may be expressed in terms of either “favorable” or “unfavorable” in comparison to past successful cases, or may be expressed as a number on a scale of favorability (e.g., a scale of 1-10 may be employed, with 1 indicating the greatest deviation from favorable cases and 10 indicating the least deviation from favorable cases). The deviation from favorable cases in some embodiments may take into consideration only deviation in an unfavorable direction (e.g., processes that are taking longer than desirable may be considered deviations, while deviations in the direction of processes being performed more timely than reference cases may be disregarded). The processing unit 120 in various embodiments periodically updates the evaluation of the operational parameters to provide the performance metric. For example, if a performance metric includes or is based on an elapsed time until a given process is performed, the performance metric may be re-calculated (e.g., every 5 seconds) as the elapsed time increases. Yet further, still, the display of the performance metric includes alert levels corresponding to the performance metric in various embodiments. For example, as a performance metric corresponding to elapsed time degrades with increased lapsed time, various levels of alerts (e.g., messages, color-coded indications, and/or audible alarm sounds) may be provided via the display unit 140.

As indicated herein, the processing unit 120 is configured to control various aspects of the system 100 and/or to reconstruct one or more images using information obtained via an acquisition unit, as well as to evaluate the patient process progress state. It may be noted that in some embodiments the patient process progress state may be determined using only operational parameters, in some embodiments the patient process progress state may be determined using only clinical parameters, and in some embodiments the patient process progress state may be determined using both clinical and operational parameters.

The depicted processing unit 120 is operably coupled to the input units, the display unit 140, and the data store 130. The processing unit 120, for example, may receive information from the input units regarding the performance of various processes and/or clinical information describing the condition of a patient that may be utilized in determining a patient process progress state. The processing unit 120 in various embodiments receives user inputs from the input units that describe a particular process performed as well as the timing of the performance of the process. As another example, the processing unit 120 may receive imaging data or projection data from an imaging unit (e.g., CT detector 114) or other diagnostic information (e.g., results of blood tests, EKG information, or the like). As one more example, the processing unit 120 may provide control signals to one or more aspects of an imaging unit, such as the CT acquisition unit 110, for example the X-ray source 112 and CT detector 114. The processing unit 120 may include processing circuitry configured to perform one or more tasks, functions, or steps discussed herein. It may be noted that “processing unit” as used herein is not intended to necessarily be limited to a single processor or computer. For example, the processing unit 120 may include multiple processors and/or computers, which may be integrated in a common housing or unit, or which may distributed among various units or housings.

In the embodiment depicted in FIG. 1, the processing unit includes a reconstruction module 122, a determination module 124, a control module 126, and a memory 128. It may be noted that other types, numbers, or combinations of modules may be employed in alternate embodiments, and/or various aspects of modules described herein may be utilized in connection with different modules additionally or alternatively. Generally, the various aspects of the processing unit 120 act individually or cooperatively with other aspects to perform one or more aspects of the methods, steps, or processes discussed herein (e.g., method 300 or aspects thereof). In the depicted embodiment, the memory 128 includes a tangible, non-transitory computer readable medium having stored thereon instructions for performing one or more aspects of the methods, steps, or processes discussed herein. In various embodiments, the memory 128 may include all or a portion of the data store 130.

The depicted reconstruction module 122 is configured to reconstruct one or more images using imaging or projection data acquired from the first imaging unit 102 and/or the second imaging unit 104 (e.g., from the CT detector 114 of the first imaging unit 102). For example, the reconstruction module 122 may receive imaging information from the CT detector 114 taken over a number of views (e.g., for a full rotation or portion thereof, or for a number of rotations taken at different positions along the length of an object to be imaged) and reconstruct an image used for diagnostic purposes. In some embodiments, the reconstruction module 122 may determine one or more objective parameter values (for use in determining a patient process progress state) based on a reconstructed image. In some embodiments, a viewer may provide an input from which a parameter value (for use in determining a patient process progress state) is determined based on a displayed reconstructed image.

In the illustrated embodiment, the determination module 124 is configured to receive information from one or more of the input units and to determine a patient process progress state. The determination module 124, for example, may utilize operational and/or clinical parameters in determining the patient process progress state. Operational parameters may be useful, for example, to evaluate how health care providers are performing the required or desired processes for a therapeutic cycle relative to past successful cases. Clinical parameters may be useful, for example, to evaluate that patient's condition as it develops through the therapeutic cycle relative to past successful cases. Generally, the determination module may determine a patient process progress state by comparing values of one or more operational parameters (and/or clinical parameters) for a current patient with reference values of the parameters. In some embodiments, a Z-score may be provided for the current patient relative to a reference population. It may be noted that the reference population may be modified as a therapeutic process develops. For example, a patient may be initially examined exhibiting symptoms of stroke, and the reference population may include different types of previous stroke patients. However, as the therapeutic cycle develops, it may be determined that the patient is experiencing an ischemic stroke, and the population refined to include past patients that experienced ischemic strokes and to exclude past patients that experienced hemorrhagic stroke.

In the illustrated embodiment, the control module 126 is configured to control the CT acquisition unit 110 and/or other aspects of the system 100, for example to perform imaging scans. For example, responsive to a user input, the control module 126 may control the CT acquisition unit 110 to perform a particular scan. At or near the same time, the control module 126 (or other aspect of the system 100 such as the CT acquisition unit 110) may communicate to the determination module 124 that a particular type of scan has been initiated and/or completed at a time, with the determination module 124 then determining the value of an operational parameter (e.g., a timing parameter corresponding to the particular scan) using the provided information. It may be noted that other types of scans or processes may be initiated by the control module 126 and communicated to the determination module 124.

The depicted determination module 124 is communicably coupled to the various input units and receives information relating to processes that have been performed and/or a patient's medical condition. For example, the determination module 124 may receive information from an input unit (e.g., first input unit 101, second input unit 102, third input unit 103, fourth input unit 104, fifth input unit 105, control module 126) regarding a time at which a particular process has been performed. Alternatively or additionally, the determination module 124 may receive information describing a patient's health (e.g., past medical conditions, patient characteristics such as age or weight, previous medications, results of tests or exams (e.g., waveform information, imaging information), or the like. The determination module 124, in the illustrated embodiment, is communicably coupled to the data store 130, and compares values of obtained operational parameters with reference values (e.g., reference values corresponding to successful or favorable outcomes) to determine a patient process progress state.

The depicted display unit 140 is operably coupled to the processing unit 120, and is configured to display information corresponding to the patient process progress state determined by the processing unit 120. For example, the display unit 140 may display Z-scores or other measures of the closeness or similarity of the values of one or more operational parameters (and/or one or more clinical parameters) to reference values. As another example, the display unit 140 may indicate a relative level of acceptability of current performance of processes for the therapeutic cycle or patient journey. For example, if the operational parameters for a current therapeutic cycle compare favorably with past successful cases, the display unit 140 may indicate that the processes for the current therapeutic cycle are being performed in a timely or satisfactory manner. However, if the operational parameters deviate beyond a threshold value, or the patient process progress state does not compare favorably with past cases having successful outcomes, a warning or other indication may be displayed.

The display unit 140 in various embodiments is configured to make an operator aware of whether or not the various processes are being performed consistent with successful cases in past, and may provide warnings and/or recommendations. For example, a warning may displayed when obtained operational parameters (and/or clinical parameters) match or correspond to reference values for cases having an unfavorable outcome, or when the parameters deviate beyond a predetermined limit from cases having a favorable outcome. In some embodiments, the display unit 140 may display a suggestion for a next process to be performed, and/or timing (e.g., a window of preferred or acceptable time, or a displayed countdown corresponding to time remaining for preferred performance of a given process or processes) for performance of one or more upcoming processes. In some embodiments, a color coded display may be provided by the display unit 140. For example, when a patient process progress state corresponds favorably to past cases with favorable outcomes, a green indicator may be displayed, but when a patient process progress state does not correspond favorably to past cases with favorable outcomes, a red indicator may be displayed. Further, audible indicators may be provided alternatively or additionally.

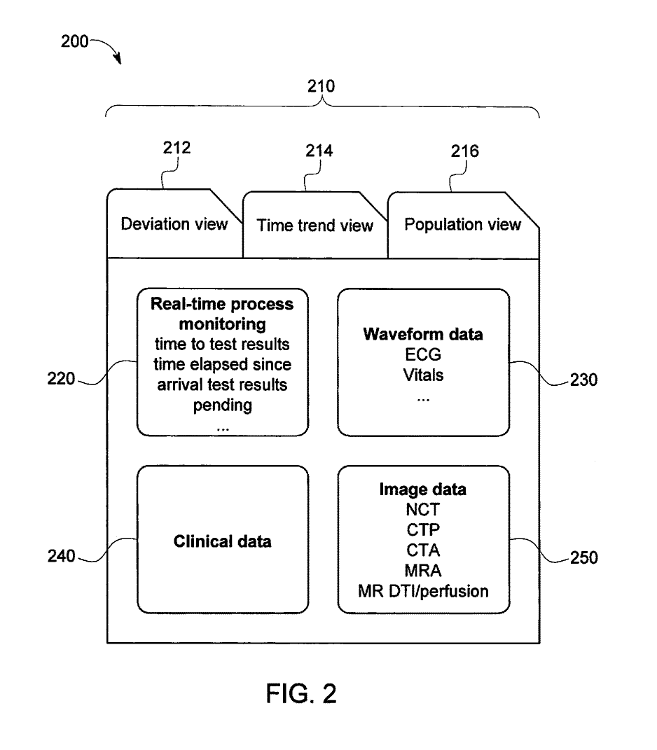

Additionally, other information as well as information regarding a patient process progress state may be displayed in various embodiments. For example, FIG. 2 depicts an example display 200 in accordance with various embodiments. The example display 200 may be displayed on a display unit 140 that is viewable in one or more of a mobile location (such as on a smartphone or tablet in an ambulance), at an admitting location, in an emergency room, in an operating room, at a hospital or clinic to be viewed by a doctor, nurse, or other healthcare provider, at an administrative location (e.g., for reviewing past processes to determine compliance with best practices and/or to develop new processes or changes to existing processes), or the like. The display 200 includes tabs 210 that include a deviation view tab 212, a time trend view tab 214, and a population view tab 216. When the deviation view tab 212 is selected, the display 200 provides information regarding the deviation of one or more operational parameters (and/or clinical parameters) from reference values corresponding to favorable outcomes. When the time trend view tab 214 is selected the display 200 provides information regarding the time trends of one or more operational parameters (and/or clinical parameters) and/or time trends of deviations of the parameters from reference values corresponding to favorable outcomes. When the population view tab 216 is selected, the display 200 provides information regarding the population from which the reference values were derived. For example, reference values of operational parameters or time trends of operational parameters may be displayed in some embodiments. For a therapeutic cycle having a known or expected sequence of processes, based on the most recent process identified as performed, the display 200 may indicate a reference value for a time elapsed to perform the next process in the sequence determined from cases with favorable outcomes. Additionally or alternatively, information describing or relating to the reference population may be displayed. For example, the particular therapeutic cycle of the reference population may be displayed, and/or characteristics such as range of ages, range of sizes, gender, or the like of the reference population may be displayed. Further still, the makeup of the reference population may be interactively modified using the display unit 140. For example, the display 200 may indicate that the reference population includes all stroke patients. However, an image displayed on the display unit 140 may indicate that the current patient has experienced an ischemic stroke. Accordingly, an operator may provide an input refining the reference population to include ischemic stroke cases but exclude hemorrhagic stroke cases. Reference values from the refined population may be used by the processing unit 120 for subsequent evaluation and/or updating of the patient process progress state as the therapeutic cycle continues.

As seen in FIG. 2, the illustrated example display 200 includes a first portion 220, a second portion 230, a third portion 240, and a fourth portion 250. The first portion 220 displays graphics and/or information relating to process evaluation (e.g., regarding the patient process progress state for a current patient in a therapeutic cycle). For example, the first portion 220 may indicate information relating to the values of operational parameters for a current patient and/or reference values determined from previous cases, as well as a comparison of the current and reference values, and/or measure based on the comparison of the current and reference values. The first portion 220, for example, may display timing information of one or more processes, an indication of which processes have been performed and/or are expected to be performed, or the like. The first portion 220 may also display the patient process progress state (e.g., Z-scores or other measures of the similarity of values of operational and/or clinical parameters of a current case and reference values of successful cases), warnings or alerts based on differences between the current case and successful cases, and/or recommendations for future actions in the therapeutic cycle (e.g., performance of a particular process before performance of a different process, performance of the next scheduled process within a desired time frame, or the like). The first portion 220 may display real-time information, such as an updated patient process progress state based on one or more of a recent process or sequence of processes that have been performed, an updated elapsed time since one or more processes have been performed, an updated time of pendency of test results or other process result, or the like.

The second portion 230 displays graphics and/or information regarding waveform data. For example, an EEG and/or EKG, either current or previously obtained may be displayed on the second portion 230. Additionally or alternatively, an objective measure derived from a waveform such as an EEG or EKG may be displayed. Further still, timing information corresponding to when a particular waveform was obtained may be displayed. Yet further still, a waveform corresponding to one or more cases having a positive outcome may be displayed for comparison purposes.

The third portion 240 displays graphics and/or information regarding clinical data, such as patient history information (including past conditions, past medications, prior health status such as mRS functionality scale score, or the like), patient characteristics (including gender, weight, age, history of smoking and/or drinking, or the like), test or exam results or other information regarding the present illness or medical condition (e.g., blood pressure, heart rate, lipid profile, creatinine blood test, hemoglobin A1C test stroke attribute check such as F-A-S-T (face-arms-speech-time), Glasgow coma score, time of onset, severity of symptoms, NIH stroke scale score (total score and/or individual components of score), or the like.

The fourth portion 250 displays graphics and/or information regarding imaging information. For example, one or more of an X-ray image, a CT image, MRI image, PET image, SPECT image, NM image, or ultrasound image, either current or previously obtained, may be displayed on the fourth portion 250. Additionally or alternatively, an objective measure derived from an image, such as an objective measure or measures from a CT perfusion image may be displayed. Further still, timing information corresponding to when a particular image was obtained may be displayed. Yet further still, one or more images corresponding to one or more cases having a positive outcome may be displayed for comparison purposes. It may be noted that the fourth portion 250 (and/or other portions of the display 200) may be configured for interactive use. For example, a user may be allowed to select a different view or different image. As another example, a user may use the fourth portion 250 to select a next image in a sequence to be performed (e.g., based on results of one image, a follow up image may be selected—for instance, if ischemic stroke is determined after analysis of a non-contrast CT image, a user may designate a CTA scan to be performed). Further, a user may be allowed to enter a value or decision based on a displayed image.

It may be noted that the display 200 may be updated in real-time with information currently collected at or near display, or with information collected remote (i.e., at a different physical location or facility) from the display. The illustrated embodiment shows a single display for ease of illustration; however, it may be noted that multiple display units may be used at the same or different times. For example, all or a portion of the display 200 may be provided to personnel in an ambulance using a smartphone or tablet, while all or a portion of the display 200 may also be shown at one or more workstations in a facility such as a clinic or hospital. The particular configuration of the display and information shown may be tailored for the location at which the display is provided. For example, the display in an ambulance may show the patient process progress state along with a recommended time for performing a particular test or other process in the ambulance, while the display at a hospital to which the patient is being transported may show the patient process progress state along with recommended time frames for particular tests or other processes to be performed after the patient arrives at the hospital. It may be further noted that the display unit 140 may include one or more of a screen, a touchscreen, a printer, or the like.

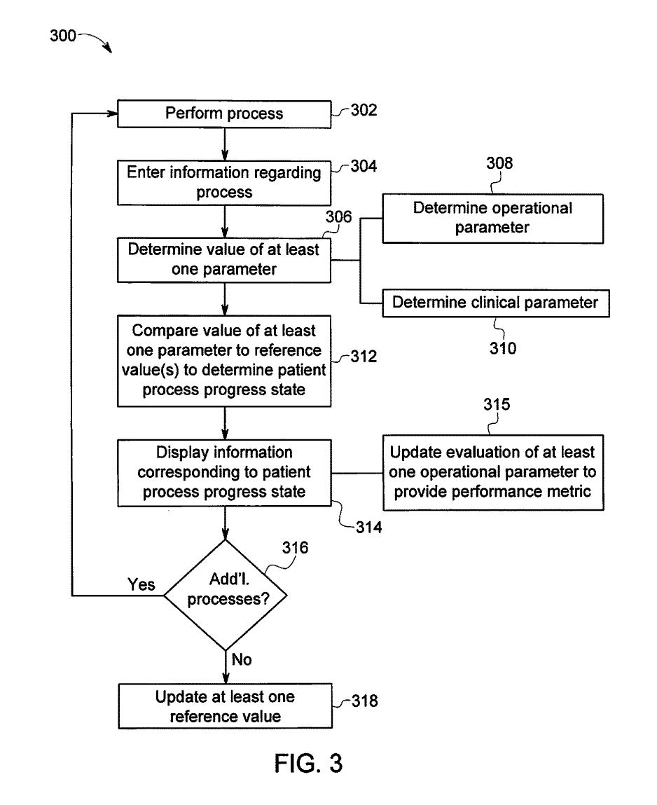

FIG. 3 provides a flowchart of a method 300 for determining a patient process progress state. The method 300, for example, may employ or be performed by structures or aspects of various embodiments (e.g., systems and/or methods) discussed herein. In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion. In various embodiments, portions, aspects, and/or variations of the method 300 may be able to be used as one or more algorithms to direct hardware (e.g., one or more aspects of the processing unit 120) to perform one or more operations described herein.

At 302, a process is performed during a therapeutic cycle (or patient journey) of a patient. Generally, the process is one of a sequence of operational processes performed by one or more healthcare providers (e.g., one or more providers and/or individuals including but not limited to doctors, nurses, therapists, emergency medical technicians, administrative staff, hospitals, clinics, urgent care facilities, among other others) occurring from onset to resolution of a patient condition (i.e., during a therapeutic cycle or patient journey). An operational process may include, for example, performance of a test or exam, collection of information, imaging a patient, picking up a patient, or admitting a patient to a facility, among others.

At 304, information regarding the process is entered via an input unit (e.g., any of the input units 101, 102, 103, 104, 105 discussed in connection with FIG. 1). For example, the information may include time of a performance of a process and/or additional details describing or identifying the process. The information may relate to an operational aspect of a therapeutic process (e.g., an identification of a particular process performed, an identification of a sequence of process performed, and/or timing information regarding performance of one or more processes). Additionally or alternatively, the information may include diagnostic information that relates to a clinical aspect of a therapeutic cycle, including information describing a patient health state such as clinical history, imaging information, wave form information, blood test information, or other test or exam result. The information may be entered manually by an operator, or may be entered automatically (e.g., by an imaging system that has obtained an image of the patient).

At 306, a value of at least one parameter related to the therapeutic cycle or patient journey is determined. The value may be determined by a processor (e.g., processing unit 120) using information obtained at 304. In some embodiments, the value of the parameter may be directly entered at 304, and the at least one processor may be understood as determining the parameter upon reception from an input unit. In some embodiments, the value of the parameter may be derived from information entered at 304. For example, a time of performance may be entered at 304 and the at least one processor may determine a time lapse between the time of performance and a previous reference time (e.g., a time of performance of a previous process). In various embodiments, operational and/or clinical parameter values may be determined.

For example, at 308 of the illustrated embodiment, a value of at least one operational parameter is determined. The at least one operational parameter may include at least one timing parameter (e.g., time elapsed since performance of a given process, time elapsed between performance of two processes, time of performance of a given process with respect to a predetermined baseline, or the like). The parameter may represent, for example, that a particular process has been performed, whether or not the process was successfully performed, the time it took to perform the process, the time elapsed since the process has been performed, and/or a sequence in which a number of processes were performed.

As another example, at 310 of the illustrated embodiment, a value of at least one clinical parameter is determined. As used herein, clinical parameters relate to the health or condition of a patient, and may relate to, for example, a result of an imaging test or information obtained from an image, results of blood tests, wave form tests, or other tests or exams, or clinical history or background information of a patient (e.g., age, gender, previous conditions, current or previous medications, or the like). It may be noted that, while the performance of some process may result in obtaining one or more clinical parameters and/or information from which one or more clinical parameters may be determined, a process need not necessarily be performed to obtain a clinical parameter. It may further be noted that, for processes which result in obtaining a clinical parameter, both operational parameters (e.g., timing information regarding performance of a scan) and clinical parameters (e.g., clinical information derived from an image generated as a result of the scan) may be obtained or determined, and used to evaluate a patient process progress state.

At 312, the value of at least one parameter (e.g., at least one operational parameter and/or at least one clinical parameter determined at 306, 308, and/or 310) is compared to at least one reference value to determine a patient process progress state. In the illustrated embodiment, the at least one reference value corresponds to at least one known patient outcome. For example, reference values for operational and/or clinical parameters for successful past patient outcomes may be stored. The reference values may include a mean parameter value and a standard deviation, for example. As another example, the reference value may include a range of acceptable values corresponding to past successful patient outcomes. The reference values may be used for evaluating a single parameter or a group of parameters individually in some embodiments. Additionally, or alternatively, a functional relationship may be based on a group of parameter values and used to evaluate the parameters collectively as a group. In such a group evaluation, parameters that are found to have a greater impact on the likelihood of a successful outcome may be weighted more heavily in defining the functional relationship. In some embodiments, the reference values may correspond to only a single outcome (e.g., a successful outcome), with values of parameters evaluated for similarity to parameter values for the single outcome. In other embodiments, reference values for a range of outcomes may be employed, with the most similar likely outcome determined by the closest reference value to the current value.

It may be noted that, in some embodiments, the patient process progress state may be represented or indicated by one or more Z-scores based on a comparison of currently obtained parameter values with reference values for successful cases. The patient process progress state may be determined by deviations of current parameters from reference values and/or time trends of parameter values as discussed herein.

At 314, information corresponding to the patient process progress state is displayed. The information may be displayed, for example, on a display unit such as display unit 140. The information may include the determined patient process progress state (e.g., as represented by one or more Z-scores) and/or a display related to the patient process progress state (e.g., an alarm or other indicator based on similarity or dis-similarity to past cases having successful outcomes; a performance metric based on the similarity to previous successful cases, or the like). The display in various embodiments includes one or more aspects discussed in connection with FIG. 2. Accordingly, in some embodiments, one or more of imaging information, waveform information, and clinical information are displayed concurrently with the information corresponding to the patient process progress state.

It may be noted that, in addition to displaying a performance metric corresponding to the patient process progress state, the evaluation of at least one operational parameter may be periodically updated to provide the performance metric at 315. For example, the performance metric may be based on an elapsed time since one or more processes have been performed. As more time elapses, the performance metric may be updated until the one or more processes have been performed. Further, the display may provide guidance to an operator to perform the one or more processes within a specified period of time.

At 316, it is determined if any additional processes are to be performed. The determination of if additional processes are to be performed, as well as the particular processes to be performed, may be determined based on the patient process progress state and/or information from which the patient process progress state was derived. Accordingly, one or more additional processes may be performed based on the patient process progress state. For example, the selection and implementation of a particular process or sequence of processes may be made based on the patient process progress state (e.g., if the patient process progress state compares favorably to successful past outcomes, the process sequence for the successful past outcome may be followed, but if the patient process progress state deviates from the past successful cases, one or more remedial or mitigating steps may be performed). As another example, the performance of a scheduled or planned process may be specified to be performed within a specified amount of time to satisfy a timing target associated with successful outcomes. If additional processes are to be performed, the method 300 returns to 302. If no additional processes are to be performed, the method 300 proceeds to 318. It may further be noted that the evaluation of operational and/or clinical parameters may be modified as the method 300 proceeds. For example, in various embodiments, the reference values correspond to a peer population of the patient, such as past patients with successful outcomes undergoing a similar patient journey. However, as the current patient journey progresses, additional information may be obtained to refine the peer population. For example, imaging information may be obtained from the patient, and the peer population re-defined using the imaging information. For example, imaging information may be used to determine if the current patient is experiencing ischemic stroke or hemorrhagic stroke, with the peer population (and corresponding reference values) re-defined based on the type of stroke being experienced by the patient.

At 318, at least one reference value is updated using at least one parameter (e.g., clinical parameter, operational parameter) determined at 306, 308, and/or 310. For example, if the therapeutic cycle or patient journey results in a successful outcome, the value of the operational and/or clinical parameter(s) may be added to the previous values for successful cases to provide an updated reference population, and a mean and standard deviation computed for the updated reference population to provide updated reference values.

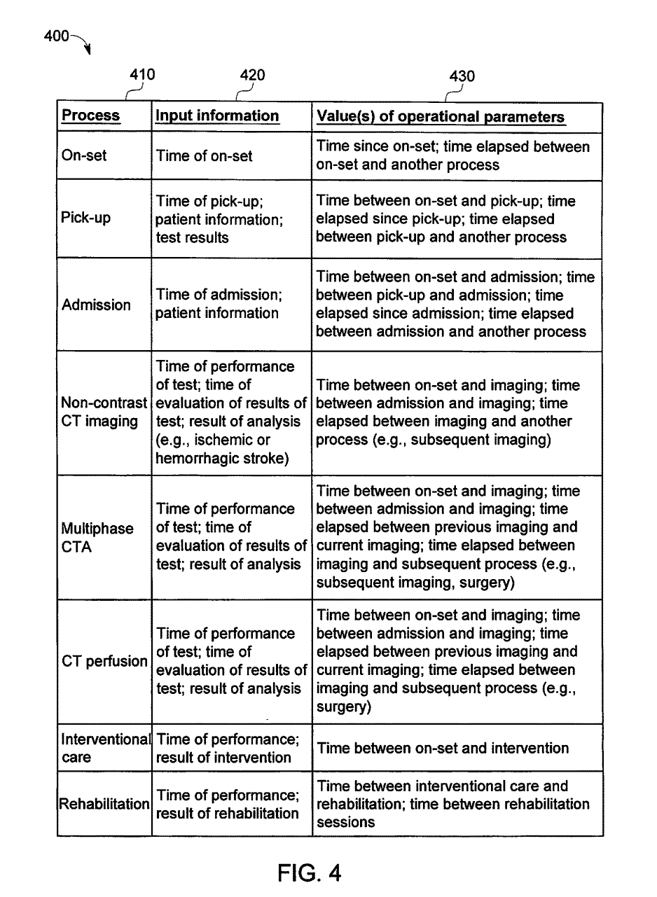

As discussed herein, various operational and/or clinical parameters may be used to evaluate a patient process progress state. FIG. 4 provides a chart 400 illustrating various processes 410, corresponding information 420 that may be entered, and operational parameters 430 that may be employed in the illustrated example. It may be noted that the illustrated example is for a therapeutic cycle corresponding to a stroke and is meant by way of example for illustrative purposes and not limitation. Other patient journeys or therapeutic cycles, and/or other parameters may be employed in various embodiments. It may further be noted that for clarity and ease of illustration, only operational parameters are listed in the depicted example; however, clinical parameters obtained or determined at any of the various stages may also be employed additionally or alternatively in determining a patient process progress state. For example, certain types of input information (e.g., patient information, imaging results, intervention results, rehabilitation results) shown in FIG. 4 may be understood as diagnostic information from which the values of one or more clinical parameters may be obtained or determined.

In the illustrated example, the first process is on-set. On-set may be understood as a time when a patient first exhibits symptoms. Input information regarding on-set may include, for example, a time of on-set. Input information regarding on-set may be entered at or near the actual time of on-set (e.g., during a 911 call) or may be entered later (e.g., the time of on-set may be reported when the patient is picked up in an ambulance). Example values of operational parameters corresponding to on-set may include a time elapsed since on-set, or, as another example, a time elapsed between on-set and another process. The operational parameter value may be a fixed value (e.g., a time between on-set and the actual performance of a subsequent process), or a value that may be updated (e.g., a running total time elapsed since on-set that is maintained and periodically updated throughout all or a part of the patient journey or therapeutic cycle.

The next process in the depicted example is pick-up (e.g., picking up the patient in an ambulance). Operational information (e.g., the time of pick-up) from which operational parameters may be determined may be entered. Additionally or alternatively, diagnostic information (e.g., patient information such as age, condition, score on a stroke symptom test, or result of other test) from which clinical parameters may be determined may be entered. Operational parameters corresponding to pick-up in various embodiments include one or more of time between on-set and pick-up, time elapsed since pick-up (which may be periodically updated), and time elapsed between pick-up and another process (such as admission).

In the depicted example, the next process is admission. Operational information (e.g., the time of admission) from which operational parameters may be determined may be entered at or near the time of admission. Additionally or alternatively, diagnostic information (e.g., patient information such as age, condition, or result of a test or exam) from which clinical parameters may be determined may be entered. Operational parameters corresponding to admission in various embodiments include one or more of time between on-set and admission, time elapsed since admission (which may be periodically updated), and time elapsed between admission and another process (such as one or more imaging scans).

The next process in the illustrated example is non-contrast CT imaging. Non-contrast CT imaging may be used, for example, to help distinguish between hemorrhagic and ischemic strokes. As the time from on-set to treatment may be important for a successful outcome, and the type of treatment provided depends on diagnosing the type of stroke, various timing parameters regarding non-contrast CT imaging may be quite useful in determining the patient process progress state, and minimizing the timing required to provide a successful analysis of non-contrast CT image (as well as other imaging information) will help increase the likelihood of a favorable or successful outcome. As seen in FIG. 4, input information may include operational information such as time of performance of test, or time of evaluation of results, as well as diagnostic information such as result of analysis (e.g., determining between ischemic and hemorrhagic stroke). Additionally, the type of stroke determined may be used to refine the patient population and reference values used to determine the patient process progress state. The operational parameters corresponding to non-contrast CT imaging, as shown in FIG. 4, include timing information from various process and imaging, as well as timing information from imaging to subsequent processes.

The next process in the illustrated example is multiphase CT imaging. For example, for cases where ischemic stroke is diagnosed, multiphase CT imaging may be used, to help determine a course of treatment (e.g., whether or not removal of a blood clot is appropriate, and/or the location of a blood clot to be removed). As seen in FIG. 4, input information may include operational information such as time of performance of test, or time of evaluation of results, as well as diagnostic information such as result of analysis (e.g., determining whether blood clot removal is appropriate, determining if further information is required). The operational parameters corresponding to multiphase CT imaging, as shown in FIG. 4, include timing information from various process and imaging, as well as timing information from imaging to subsequent processes.

In the depicted example, the next process is CT perfusion imaging. For example, for cases where multiphase CT imaging does not provide sufficient information regarding the appropriateness of removing a blood clot, CT perfusion imaging may be used, to help determine a course of treatment (e.g., whether or not removal of a blood clot is appropriate). As seen in FIG. 4, input information may include operational information such as time of performance of test, or time of evaluation of results, as well as diagnostic information such as result of analysis (e.g., determining whether blood clot removal is appropriate). The operational parameters corresponding to CT perfusion imaging, as shown in FIG. 4, include timing information from various process and imaging, as well as timing information from imaging to subsequent processes.

The next depicted process is interventional care. For example, if CT perfusion imaging results indicate that removal of a blood clot is appropriate, surgery may be performed to remove the blood clot. Information entered corresponding to interventional care may include an identification of the type of interventional care, the time of performance of interventional care, results of interventional care, and/or diagnostic information (e.g., a patient's score on one or more stroke evaluation tests before and/or after interventional care). Timing between interventional care and other processes or events (e.g., on-set, diagnosis, one or more imaging tests, among others) may be used as operational parameters to evaluate a patient process progress state.

The next depicted process is rehabilitation. Information entered corresponding to interventional care may include an identification of the type of rehabilitation, the time of performance and/or frequency of rehabilitation, results of rehabilitation, and/or diagnostic information (e.g., a patient's score on one or more stroke evaluation tests before and/or after one or more rehabilitation sessions). Timing between rehabilitation sessions themselves and/or other processes or events (e.g., on-set, diagnosis, interventional care, among others) may be used as operational parameters to evaluate a patient process progress state.

Accordingly, various operational and/or clinical parameters may be used to evaluate a patient process progress state along a patient journey or therapeutic cycle. The patient process progress state may be used to provide information and/or guidance regarding a current patient being analyzed. Additionally or alternatively, the patient process progress state for a number of patients may be evaluated to provide information and/or guidance regarding practices, for example practices of a given facility. For instance, a number of patient process progress states for patients having defined outcomes may be evaluated to identify areas which may be improved (e.g., if a time between two processes is shown to strongly correlated to successful outcomes, a facility may review its practices to help ensure that a satisfactory time is elapsing between those two processes).

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid-state drive, optical disk drive, and the like. The storage device may also be other similar means for loading computer programs or other instructions into the computer or processor.

As used herein, the term “computer.” “module,” or “unit” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein. Instead, the use of “configured to” as used herein denotes structural adaptations or characteristics, and denotes structural requirements of any structure, limitation, or element that is described as being “configured to” perform the task or operation. For example, a processing unit, processor, or computer that is “configured to” perform a task or operation may be understood as being particularly structured to perform the task or operation (e.g., having one or more programs or instructions stored thereon or used in conjunction therewith tailored or intended to perform the task or operation, and/or having an arrangement of processing circuitry tailored or intended to perform the task or operation). For the purposes of clarity and the avoidance of doubt, a general purpose computer (which may become “configured to” perform the task or operation if appropriately programmed) is not “configured to” perform a task or operation unless or until specifically programmed or structurally modified to perform the task or operation.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f) unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal language of the claims.

What is claimed is:

1. A system comprising:
an input unit configured to obtain operational parameters relating to the performance of at least one process during a therapeutic cycle of a patient;
a data store including reference values of the operational parameters that correspond to at least one known patient outcome;
at least one processor operably coupled to the input unit and configured to evaluate the operational parameters to determine a patient process progress state based on a comparison between values of the operational parameters and corresponding reference values; and
a display unit operably coupled to the at least one processor, the display unit configured to display information corresponding to the patient process progress state.

2. The system of claim 1, wherein the input unit is configured to obtain clinical parameters relating to diagnostic information of the patient, wherein the data store includes reference values of the clinical parameters that correspond to the at least one known patient outcome, and wherein the at least one processor is further configured to evaluate the clinical parameters to determine the patient process progress state.

3. The system of claim 1, wherein the at least one processor is further configured to update the reference values using the obtained operational parameters.

4. The system of claim 1, wherein the operational parameters comprise at least one timing parameter.

5. The system of claim 4, wherein the at least one timing parameter includes a time since a test has been performed.

6. The system of claim 4, wherein the at least one timing parameter includes a time since arrival at a facility.

7. The system of claim 1, wherein the at least one processor is configured to evaluate the operational parameters to provide, via the display, a performance metric corresponding to the patient process progress state.

8. The system of claim 7, wherein the at least one processor is configured to periodically update the evaluation of the operational parameters to provide the performance metric.

9. The system of claim 8, wherein the display of the performance metric comprises alert levels corresponding to the performance metric.

10. The system of claim 1, wherein the reference values are used to correlate the values of operational parameters and patient outcomes based on successfulness or unsuccessfulness.

11. The system of claim 1, wherein the reference values correspond to a peer population of the patient, wherein the at least one processor is configured to obtain imaging information of the patient, and wherein the at least one processor is configured to re-define the peer population using the imaging information.

12. The system of claim 1, wherein the display unit is configured to display imaging information, waveform information, and clinical data concurrently with the information corresponding to the patient process progress state.

13. A method comprising:
performing a process during a therapeutic cycle of a patient;
entering information regarding the process into an input unit;
determining, with at least one processor, a value of at least one operational parameter using the information regarding the process;
comparing the value of at least one operational parameter to at least one reference value corresponding to at least one known patient outcome, to determine a patient process progress state; and
displaying, on a display unit, information corresponding to the patient process progress state.

14. The method of claim 13, further comprising performing an additional process based on the patient process progress state.

15. The method of claim 13, further comprising entering diagnostic information of the patient and determining a value of at least one clinical parameter using the diagnostic information, the method further comprising comparing the value of the at least one clinical parameter to at least one reference value of clinical parameters corresponding to the at least one patient outcome to determine the patient process progress state.

16. The method of claim 13, further comprising updating the at least one reference value using the at least one operational parameter.

17. The method of claim 13, wherein the at least one operational parameter comprises at least one timing parameter.

18. The method of claim 13, wherein displaying the information corresponding to the patient process progress state comprises displaying a performance metric corresponding to the patient process progress state.

19. The method of claim 18, further comprising periodically updating the evaluation of the at least one operational parameter to provide the performance metric.

20. The method of claim 13, wherein the at least one reference value corresponds to a peer population of the patient, the method further comprising obtaining imaging information of the patient, and re-defining the peer population using the imaging information.

21. The method of claim 13, further comprising displaying imaging information, waveform information, and clinical data concurrently with the information corresponding to the patient process progress state.
